(19) United States
(12) Patent Application Publication
(10) Pub. No.: US 2026/0192278 A1
(43) Pub. Date: Jul. 9, 2026

(54) SOLID SUBSTRATE TO IMMOBILIZE REACTIVE LIQUID

(71) Applicant: ExxonMobil Technology and Engineering Company, Spring, TX (US)

(72) Inventors: Mohsen S. Yeganeh, Newtown, PA (US); Andrew R. Konicek, Whitehouse Station, NJ (US); Arben Jusufi, Belle Mead, NJ (US); Mark A. King, Maplewood, NJ (US)

(73) Assignee: ExxonMobil Technology and Engineering Company, Spring, TX (US)

(21) Appl. No.: 19/133,613

(22) PCT Filed: Nov. 6, 2023
(86) PCT No.: PCT/US2023/078790

§ 371 Date: May 28, 2025

Related U.S. Application Data
(60) Provisional application No. 63/440,319, filed on Jan. 20, 2023.

(51) Int. Cl. B01J 19/00; B01J 19/32

(52) U.S. Cl. CPC B01J 19/0093; B01J 19/32; B01J 2219/00822; B01J 2219/00833; B01J 2219/0084; B01J 2219/00844; B01J 2219/00855; B01J 2219/0086; B01J 2219/00891; B01J 2219/00993

(57) ABSTRACT

The present disclosure relates to a system that includes: a reaction chamber comprising a working fluid inlet and a working fluid outlet; a solid substrate contained within the reaction chamber, wherein the solid substrate has a surface area of greater than 0.001 m²/g and comprises at least one primary structure; wherein a first primary structure of the at least one primary structure comprises at least one secondary structure; wherein the at least one secondary structure forms at least one aperture with an average width such that the at least one aperture stably contains a reactive liquid; and wherein the solid substrate comprises at least one void with an average void spacing greater than the average width of the at least one aperture.

### FIELD

The present disclosure relates to methods and related systems for reactor operation utilizing a solid with infused reactive liquid (SWIRL).

### BACKGROUND

A liquid-infused surface (LIS) is a chemically functionalized, textured solid substrate that is able to trap and immobilize a liquid layer tens to hundreds of micrometers thick. LIS technology has been used for protective coatings by immobilizing a nonreactive liquid on a surface in order to mitigate corrosion, prevent icing, or reduce friction or drag, for example. The LIS technology has extended to reactive liquids on substrates where the reactive liquid is to be shaped into a high surface area/volume (A/V) ratio structure by immobilization on a textured substrate. The A/V ratio maximizes the interaction of the reactive liquid with the fluid medium said reactive liquid operates on, reducing the need for energy consuming liquids processing steps. For example, removal of carbon dioxide (CO₂) from a gas mixture may utilize an amine-containing fluid immobilized on a textured surface where the gas contacts the amine-containing fluid and the CO₂ absorbs into the amine-containing fluid, thereby reducing the concentration of CO₂ in the gas mixture. When using a reactive liquid, the technology may be referred to as a “solid with infused reactive liquid” (SWIRL) that may be useful in low-energy, liquid-based reactions and separations.

Some criteria for generating a SWIRL system include using a solid with an appropriate surface chemistry, an appropriate roughness (also referred to herein as texture), and a high surface area-to-volume contact ratio (A/V) continuum geometry. These criteria allow the reactive liquid to spread within the texture on the solid and provide a high surface area between the liquid and fluid medium for reaction and separation applications.

### SUMMARY

A nonlimiting system of the present disclosure comprises: a reaction chamber comprising a working fluid inlet and a working fluid outlet; a solid substrate contained within the reaction chamber, wherein the solid substrate has a surface area of greater than 0.001 m²/g and comprises at least one primary structure; wherein a first primary structure of the at least one primary structure comprises at least one secondary structure; wherein the at least one secondary structure forms at least one aperture with an average width such that the at least one aperture stably contains a reactive liquid; and wherein the solid substrate comprises at least one void with an average void spacing greater than the average width of the at least one aperture.

A nonlimiting method of the present disclosure comprises: contacting a reactive liquid and a working fluid in a reaction chamber, wherein the reactive liquid is impregnated on a solid substrate; wherein the solid substrate has a surface area of greater than 0.001 m²/g; wherein the solid substrate comprises at least one primary structure; wherein a first primary structure of the at least one primary structure comprises at least one secondary structure; wherein the at least one secondary structure forms at least one aperture with an average width such that the at least one aperture stably contains the reactive liquid; and wherein the solid substrate comprises at least one void with an average void spacing greater than the average width of the at least one aperture.

A nonlimiting method of manufacturing a solid substrate according to the present disclosure comprises: (i) producing at least one primary structure by affixing at least one secondary structure in a configuration, wherein the at least one secondary structure forms at least one aperture with an average width such that the at least one aperture stably contains a reactive liquid; wherein the configuration comprises a spiral configuration, a piled configuration, a stacked configuration, a stacked pile configuration, a zig-zag configuration, or any combination thereof; and (ii) contacting the at least one secondary structure with the reactive liquid; wherein the solid substrate has a surface area of greater than 0.001 m²/g; wherein the solid substrate comprises at least one void with an average void spacing greater than the average width of the at least one aperture; wherein the reactive liquid impregnates at least 30% of the surface area of the solid substrate; and wherein the reactive liquid impregnates at least 5 vol % of the solid substrate.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a side view of a nonlimiting example system that comprises a reaction chamber and a solid substrate therein.

FIG. 2 is a top view of a nonlimiting example system that comprises a reaction chamber and a solid substrate therein.

FIG. 3A is a cross-sectional view of a nonlimiting example of a primary structure of the present disclosure.

FIG. 3B is a cross-sectional view of a nonlimiting example of a primary structure of the present disclosure having an impregnation of a reactive liquid thereon.

FIG. 4 is a cross-sectional view of a nonlimiting example of a primary structure of the present disclosure having a piled configuration.

FIG. 5 is a cross-sectional view of a nonlimiting example of a primary structure of the present disclosure having a stacked configuration.

FIG. 6 is an optical microscope image of an exemplary metal mesh.

FIG. 7A is an image of an exemplary metal mesh assembly (top view).

FIG. 7B is an image of an exemplary metal mesh assembly (planar view).

FIG. 8 is an optical microscope image of an exemplary metal foam.

FIG. 9A is an image of an exemplary metal foam assembly (top view).

FIG. 9B is an image of an exemplary metal foam assembly (planar view).

FIG. 10 is an image of an exemplary assembly in a stacked configuration.

FIG. 11 is an image of an exemplary assembly in a spiral configuration.

### DETAILED DESCRIPTION

The present disclosure relates to methods and related systems for reactor operation utilizing a solid with infused reactive liquid (SWIRL). More specifically, the present disclosure relates to methods and systems for constructing and operating a reactor with a SWIRL system comprising one or multiple manufactured structures therein.

The present disclosure describes SWIRL systems and methods comprising a solid substrate that comprises at least one primary structure. An individual primary structure may comprise one or more secondary structures that forms an aperture within the primary structure. The apertures formed by the secondary structures may act as capillaries that actively draw a reactive liquid from a reservoir when impregnating the primary structure with the reactive liquid. Then, when in use in a SWIRL system, the apertures may hold the reactive liquid and act as liquid reservoirs for the SWIRL system, which may increase the amount of time the SWIRL system can be operated without needing to replace spent reactive liquid. The primary structures may also have voids internally or between primary structures which may allow for a working fluid to flow therebetween, allowing for a large reactive surface area formed by the reactive liquid. As used herein, the “working fluid” refers to any fluid different than the fluid impregnating the primary structure.

The secondary structures that make up individual primary structures may be able to be manufactured with necessary surface geometry (e.g., surface porosity or surface features) necessary for SWIRL systems at a large scale prior to being assembled into a SWIRL system, thus reducing cost and effort. The system described in the present disclosure allows for rapid, cost effective, and scalable manufacturing of solid substrates with high surface area for use in SWIRL applications by assembling secondary structures into primary structures, which can then be implemented in a SWIRL system.

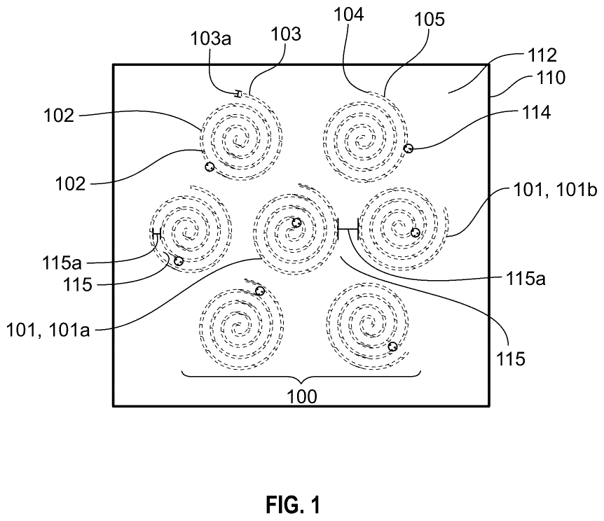

FIG. 1 illustrates a side view of at least a portion of a nonlimiting example SWIRL system of the present disclosure. The system may comprise a solid substrate 100 with at least one primary structure 101, illustrated as seven primary structures 101.

Each primary structure 101 may comprise one or more secondary structures 102. A nonlimiting example SWIRL system shown in FIG. 1 depicts two secondary structures in every primary structure. The secondary structures may have at least one aperture 103 having associated therewith a width 103a.

The average of the width 103a (or average width of the aperture 103) may be such that the secondary structures 102 may facilitate impregnation of the primary structure 101 with a reactive liquid 104 and such that the primary structure 101 may be able to stably contain the reactive liquid 104. The average of the width 103a may also be such that the primary structure 101 may be able to hold the reactive liquid 104 in place during operation of the SWIRL system so that the reactive liquid 104 in the aperture 103 functions like a reactive liquid reservoir. Without being bound by theory this impregnation, stable containment, and holding in place of the reactive liquid may occur by utilizing capillary forces and/or capillary action on the reactive liquid, generated by the secondary structures.

An “average width” when used to describe the aperture of secondary structures is defined as the numerical average distance between adjacent surface regions that may comprise a single secondary structure or between adjacent surface regions which may comprise different secondary structures.

Without being bound by theory, the average width may depend on properties of the solid substrate and/or the primary and secondary structures therein, which may include, but are not limited to, properties of the surface features and material composition. Additionally, without being bound by theory, the average width may also depend on properties of the reactive liquid.

The average width of the apertures formed by at least one secondary structures may be from about 1 μm to about 500 μm, and preferably from about 50 μm to about 100 μm (or about 1 to about 300, or about 10 μm to about 200 μm, or about 50 μm to about 200 μm, or about 100 μm to about 200 μm, or about 150 μm to about 200 μm). A single solid substrate may have secondary structures spaced at different average widths, thus forming apertures of varying sizes. For example, a first surface region of a first secondary structure may be about 25 μm from a second surface region of the first secondary structure that is adjacent to the first surface region of the first secondary structure, and the first surface region of the first secondary structure may be about 50 μm from a second secondary structure that is adjacent to the first surface region of the first secondary structure.

Referring again to FIG. 1, there may be at least one void 115 which may exist internally within a single primary structure 101 and/or externally between at least two primary structures 101a and 101b. Internally within a primary structure 101, a void 115 may exist between two secondary structures 102. Each void 115 may have associated therewith a void spacing 115a. The average of the void spacings 115a (or average void spacing internally within or externally between the primary structures 101) may be such that liquid bridging of the reactive liquid 104 within the at least one void 115 is mitigated or eliminated, and such that a working fluid 112 may be able to flow through the at least one void 115. The at least one void 115 may have an average void spacing which is greater than the average width of the at least one aperture 103.

As used herein, an “average void spacing” may refer to internal voids within primary structures or external voids between primary structures. When used to describe the void(s) between primary structures, “average void spacing” is defined as the numerical average distance between adjacent primary structures. When used to describe the void(s) within a primary structure (i.e., between two secondary structures, or within a single secondary structure), “average void spacing” is defined as the numerical average distance between adjacent surface regions that may comprise a single secondary structure or between adjacent surface regions which may comprise different secondary structures. The average void spacing may be from about 1 μm to about 1000 μm (or about 1 μm to about 500 μm, or about 10 μm to about 500 μm, 100 μm to about 500 μm, or about 10 μm to about 400 μm, or about 50 μm to about 300 μm, or about 100 μm to about 250 μm, or about 200 μm to about 500 μm, or about 300 μm to about 500 μm, or about 400 μm to about 500 μm).

A single solid substrate may have multiple voids which may have different average void spacings. For example, a first primary structure may be about 25 μm from a second primary structure that is adjacent to the first primary structure, and the first primary structure may have an internal void(s) which are 50 μm in size (i.e., may comprise two secondary structures or two regions of a single secondary structure that are 50 μm apart).

Without being bound by theory, sizing the average void spacing to prevent or mitigate liquid bridging of the reactive liquid may further depend on properties of the solid substrate, the primary structure, and/or the secondary structures therein, which may include, but are not limited to, properties of the surface features, material composition. Additionally, without being bound by theory, the average void spacing may depend on properties of the reactive liquid and/or working fluid.

Referring again to FIG. 1, the at least one secondary structures may have surface features 105.

The secondary structures of the present disclosure may comprise a rough surface, a textured surface, a porous surface, or a combination thereof, which may provide at least some of the surface features on the secondary structures.

The surface features of the secondary structures of the present disclosure may be of any suitable form including, but not limited to, particles, pillars, elongated solid features, indentations, pores, the like, and any combination thereof.

The surface features of the secondary structures of the present disclosure may have an average size (e.g., extend of protrusion from the secondary structure, depth of depression into the secondary structure, or pore size) of about 0.1 μm to about 100 μm (or 0.1 μm to 50 μm, or 1 μm to 50 μm, or 1 μm to 25 μm, or 1 μm to 10 μm, or 10 μm to 50 μm, or 25 μm to 100 μm). Further, the surface features may be spaced apart by about 0.1 μm to about 500 μm (or 0.1 μm to 500 μm, or 1 μm to 500 μm, or 1 μm to 250 μm, or 1 μm to 100 μm, or 100 μm to 500 μm).

Referring again to FIG. 1, reactive liquid 104 may impregnate the structure of the solid substrate 100 by being contained within the apertures 103. The reactive liquid may impregnate at least 20% (or at least 30%, or at least 40%, or at least 50%, or at least 60%, or at least 70%, or 20% to 100%, or 30% to 100%, or 40% to 100%, or 50% to 100%, or 60% to 100%, or 70% to 100%, or 20% to 60%, or 30% to 60%, or 40% to 60%) of the surface area of the solid substrate after the impregnating of the solid substrate with the reactive liquid.

The reactive liquid may impregnate about 100 vol % or less (or about 100 vol %, or about 80 vol % or greater, or about 60 vol % or greater, or about 50 vol % or greater, or about 40 vol % or greater, or about 20 vol % or greater, or about 10 vol % or greater, or about 5 vol % or greater, or about 1 vol % or greater, or about 0 vol %, or 0 vol %, or about 1 vol % to about 100 vol %, or about 1 vol % to about 80 vol %, or about 1 vol % to about 60 vol %, or about 1 vol % to about 50 vol %, or about 10 vol % to about 40 vol %, or about 1 vol % to about 20 vol %, or about 5 vol % to about 50 vol %, or about 5 vol % to about 100 vol %, or about 25 vol % to about 100 vol %, or about 50 vol % to about 100 vol %, or about 70 vol % to about 100 vol %, or about 80 vol % to about 100 vol %) of the solid substrate. The at least one aperture may contain the reactive liquid after the impregnation of the solid substrate with the reactive liquid.

The reactive liquid may have a contact angle with a primary structure when in the presence of a working fluid that is less than about 90 degrees (or less than about 80 degrees, or less than about 70 degrees, or less than about 65 degrees, or less than about 50 degrees, or less than about 45 degrees, or less than about 30 degrees, or less than about 20 degrees, or less than about 18 degrees, or less than about 15 degrees, or less than about 12 degrees, or less than about 10 degrees, or less than about 8 degrees, or less than about 6 degrees, or less than about 5 degrees, or less than about 4 degrees, or less than about 3 degrees, or less than about 2 degrees, or less than about 1 degree, or about 0 degrees, or 0 degrees). The contact angle quantifies the wettability of the solid substrate and can be measured using contact angle apparatus such as a static sessile drop measurement device. The contact angle can be measured for the reactive liquid and primary structure in the presence of the working fluid.

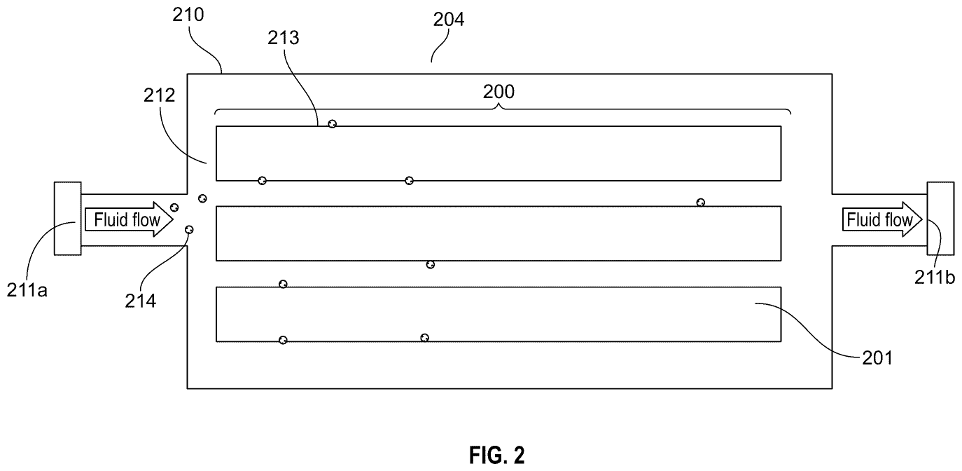

FIG. 2 shows a side view of a solid substrate 200 (containing at least one primary structure 201) which may be contained within a reaction chamber 210 of the SWIRL system. FIG. 2 shows a solid substrate 200 with three primary structures 201. The reaction chamber 210 may have a working fluid inlet 211a and working fluid outlet 211b. During use, a working fluid 212 may flow through the reaction chamber 210. A liquid-fluid interface 213 may form between the reactive liquid 204 and the working fluid 212, resulting in mass transfer and the extraction of a substance 214 from the working fluid 212 across the liquid-fluid interface 213.

The working fluid inlet and working fluid outlet may allow for fluids other than the working fluid to flow through the reaction chamber and contact the reactive fluid impregnated on and/or in the primary structures. The flowing of fluids other than the working fluid through the solid substrate may occur for purposes including regenerating the reactive liquid (e.g., regenerating with a sweeping gas) and absorbing substances (e.g., at least one substance 214 of FIG. 2) from the reactive liquid (e.g., CO₂ in flue gas). Additionally, the working fluid (or any other fluid flowing between the working fluid inlet and the working fluid outlet) may flow in any direction (e.g., from the working fluid inlet to the working fluid outlet, from the working fluid outlet to the working fluid inlet, the like, or any combinatory flow sequence thereof).

Returning to FIG. 1, shown is a hexagonal arrangement of seven primary structures 101 that make up the solid substrate 100. Other arrangements and other numbers of primary structures may be present in a solid substrate of the present disclosure.

The number of primary structures within a solid substrate of the present disclosure may be 1 to 100 or more (or 1 to 10, or 5 to 25, or 10 to 50, or 25 to 75, or 50 to 100 or more).

Where the solid substrate comprises multiple primary structures, said primary structures may be in any suitable configuration including, but not limited to, triangular, square, hexagonal, spiral, the like, and any combination thereof. Said primary structures may also be arranged in a disordered arrangement including, but not limited to, a packed bed or similar suitable configuration.

Further, FIG. 1 illustrates each primary structure 101 having two secondary structures 102 having a spiral configuration. Other configurations and other numbers of secondary structures may be present in individual primary structures of the present disclosure. Suitable configurations that support liquid impregnation of the primary structures with the reactive liquid may be utilized including, but not limited to, a spiral configuration, a piled configuration, a stacked configuration, a stacked pile configuration, zig-zag configuration, the like, and any combination thereof.

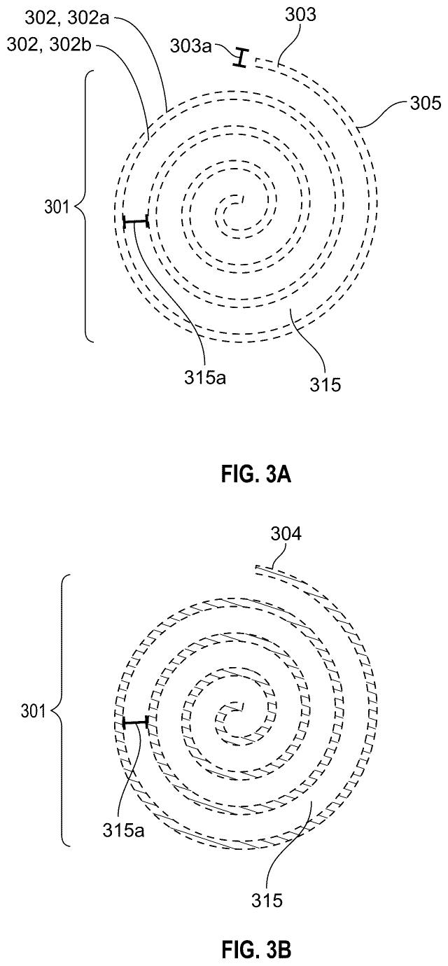

FIG. 3A illustrates a nonlimiting primary structure 301 of the present disclosure having a spiral configuration. The primary structure 301 may have at least two secondary structures 302a and 302b with at least one aperture 303 therebetween having a width 303a. The primary structure 301 may have at least one void 315 with a void spacing 315a. The primary structure 301 may be sized such that the average width of the at least one aperture 303 is smaller than the average void spacing 315a of the at least one void 315. The at least two secondary structures 302 may have surface features 305.

FIG. 3B illustrates the nonlimiting primary structure 301 of FIG. 3A which is impregnated with a reactive liquid 304 thereupon. The reactive liquid 304 immobilized within the aperture 303 between two secondary structures 302a and 302b may also form a layer on surfaces (e.g., outer surfaces) of the at least two secondary structures 302.

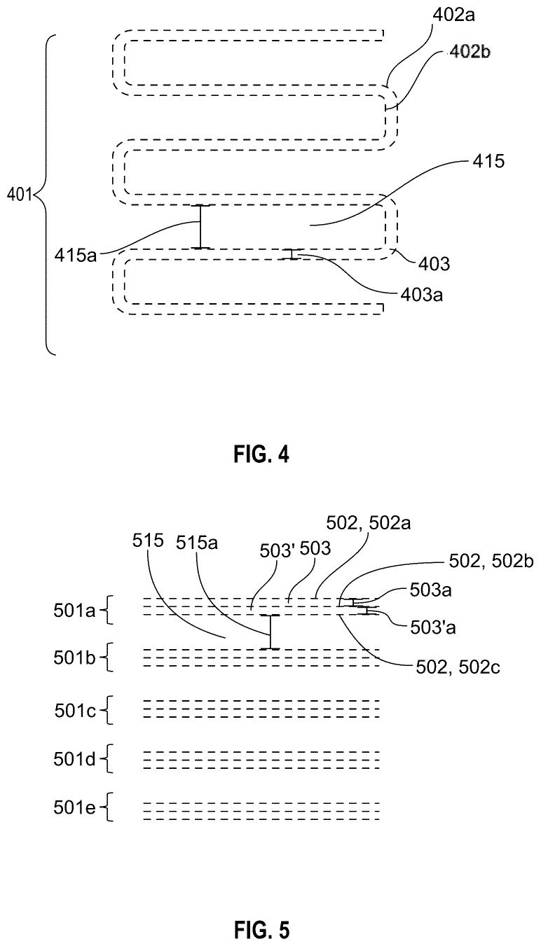

FIG. 4 illustrates a nonlimiting primary structure 401 of the present disclosure having a piled configuration. The illustrated primary structure 401 has two secondary structures 402a and 402b that define at least one aperture 403 having a width 403a. The primary structure 401 may have at least one void 415 with a void spacing 415a. The primary structure 401 may be sized such that the average width of the at least one aperture 403 is smaller than the average void spacing of the at least one void 415.

FIG. 5 illustrates a plurality of nonlimiting primary structures 501a, 501b, 501c, 501d, 501e of the present disclosure arranged in a piled configuration. Each of the primary structures 501a, 501b, 501c, 501d, 501e may have one or more secondary structures 502 (illustrated as three secondary structures 502a, 502b, 502c) where between each secondary structure 502 defines an aperture (illustrated as two apertures 503 and 503′) having a width (illustrated as widths 503a, 503′a for each of apertures 503 and 503′, respectively). Each of the primary structures 501a, 501b, 501c, 501d, 501e may have a void therebetween (illustrated as void 515 between primary structures 501a, 501b) that has a void spacing 515a. The primary structures 501a, 501b, 501c, 501d, 501e may be sized such that the average width 503a, 503′a of their respective apertures 503 and 503′ are smaller than the average void spacing 515a of the void 515. While each of the primary structures 501a, 501b, 501c, 501d, 501e are illustrated as having the same structure and dimensions, embodiments of the present disclosure include having one or more primary structures in the same SWIRL system with different structure (e.g., different secondary structures like two secondary structures and three secondary structures) and/or different dimensions (e.g., different sizes of apertures and/or different average void space).

Systems wherein each primary structure comprises a single secondary structure in spiral, stacked, or other configurations may be constructed according to the present disclosure.

While not illustrated in the foregoing figures, the primary structures of the present disclosure may further include spacers in order to maintain the void spacing internally within, the void spacing externally between primary structures, and/or the width of the apertures between the secondary structures. The spacers may be composed of any suitable material that is preferably non-reactive with the reactive liquid and the working fluid.

The solid substrates of the present disclosure may comprise primary structures that differ (e.g., different configurations, composed of different materials, include secondary structures of different thicknesses, the like, and any combination thereof).

The secondary structures of the present disclosure may be any suitable thickness where thinner may be preferred to maximize the amount of reactive fluid in the SWIRL system. The secondary structures of the present disclosure may have a thickness from about 1 μm to about 500 μm and preferably about 10 μm to 100 μm (or 10 μm to 400 μm, or 10 μm to 300 μm, or 10 μm to 200 μm, or 20 μm to 150 μm, or 50 μm to 150 μm, or 100 μm to 300 μm, or 100 μm to 200 μm).

The secondary structures may be comprised of any suitable material including, but not limited to, metal oxides (e.g., glass, quartz, silica, alumina, titania, and the like), metals (e.g., stainless steel, copper, iron, and the like), polymers (polyethylene, polypropylene, polystyrene, polyamides, polyurethanes, cellulosic polymers, and the like), the like, and any combination thereof. The material should be non-reactive with the reactive liquid. Said materials may be in any suitable form, which may include, but is not limited to, a nonporous structure, a foam, fibers, a mesh, the like, and any combination thereof. The material configuration (e.g., a foam, fibers, or a mesh) may provide at least some of the surface features on the secondary structures.

Secondary structures may be formed by several separate structures. For example, in FIG. 5 each secondary structure 502a, 502b, 502c may be a separate piece of mesh. Alternatively, at least some of the secondary structures may be continuous but shaped so as to form the apertures. For example, a structure similar to FIG. 5 may be a continuous piece of mesh that is bent and piled (e.g., a squared and flat S shape) to create the three layers (or three secondary structures) having proper spacing to create the apertures.

The secondary structures (and primary structures which may comprise secondary structures) may, together, comprise a solid substrate. The solid substrate may have a surface area of greater than 0.001 m²/g (or about 0.001 m²/g to about 45 m²/g, or about 0.001 m²/g to about 20 m²/g, or about 0.01 m²/g to about 45 m²/g, or about 0.1 m²/g to about 45 m²/g, or about 1 m²/g to about 45 m²/g).

The solid substrate may have a surface area to volume ratio (A/V) greater than 180 m⁻¹, greater than 500 m⁻¹, or greater than 1000 m⁻¹ (or 180 m⁻¹ to 1000 m⁻¹, or 500 m⁻¹ to 2000 m⁻¹, or 1000 m⁻¹ to 5000 m⁻¹, or 1000 m⁻¹ to 50000 m⁻¹). For purposes of calculation, surface area, A, is the apparent surface area provided by the external-facing surface areas of the primary structures of the solid substrate including any openings therein. For example, a metal mesh of 10 cm by 10 cm provides an apparent surface area of 100 cm² on each side of the mesh, independent of the size of openings within the mesh.

The solid substrate may have a performance index (PI) of greater than 150 m⁻¹ (or greater than 500 m 1, or 150 m⁻¹ to 1000 m⁻¹, or 150 m⁻¹ to 2000 m⁻¹, or 500 m⁻¹ to 1000 m⁻¹, or 500 m⁻¹ to 2000 m⁻¹, or 500 m⁻¹ to 5000 m⁻¹, or 500 m⁻¹ to 50000 m⁻¹). PI is defined as PI=(VI/V)(Al/V). VI and Al are the volume and surface area of the reactive liquid, respectively. VI may be determined by weighing the apparatus before and after applying the reactive liquid, and then converting the mass difference (e.g., the mass of reactive liquid held by the apparatus) into a volume using the density of the reactive liquid. Systems with a PI greater than 150 m⁻¹ are more efficient, and thus can be smaller and less expensive than conventional systems.

The surface of the solid substrates may have an appropriate solid surface functionalization that may include chemical functionalization. The solid surface functionalization, in addition to the surface features of the secondary structures, may facilitate the impregnating of the reactive liquid on the surface of the solid substrates. The reactive liquid impregnating the surface of the solid substrates keeps its liquid nature. The liquid nature of the reactive liquid may be used as the medium for separation, extraction, and enzyme immobilization in SWIRL methods and systems. For example, the reactive liquid may be able to infuse into the features on the surface or encapsulate the entire surface of the solid substrates because the liquid's chemistry allows the liquid to substantially spread onto the solid fully. The spreading is measured using the liquid contact angle on the solid.

Impregnation of solid substrates described herein with reactive liquids and applications and systems thereof are discussed in more detail in US Patent App. Pub. Nos. 2020/0147543, 2020/0147545, and 2020/0147519, which are incorporated herein by reference. Briefly, the one or more primary structures of the solid substrate may be contacted with a reactive liquid (e.g., while the reactive liquid is in a reservoir). The capillary force in the aperture(s) (the aperture(s) defined by the secondary structure(s) of each primary structure) may act to draw the reactive liquid into the aperture(s) and onto the surfaces of the primary structure. As a result, the surface (e.g., the outer surface) of each primary structure may be at least partially impregnated with the reactive fluid, and the apertures may be at least partially filled with the reactive fluid.

Examples of reactive liquids may include, but are not limited to, an amine, monoethanolamine, tetraethylpentamine (TEPA), monoethanolamine (MEA), diethanolamine (DEA), and triethanolamine (TEA), dimethylaminoethanol (DMAE), 2-(methylamino)-2-methyl-1-propanol (MAMP), 2-amino-2-methyl-1-propanol (AMP), 2-piperidine methanol, 2-piperidine ethanol, 2-amino-2-methyl-1-propanol, 2-amino-2-methyl-1-butanol, 3-amino-3-methyl-2-pentanol, 3-amino-3-methyl-1-butanol, 2-piperidine alkanol, an alkali metal hydroxide, potassium hydroxide, sodium hydroxide, lithium hydroxide, glycol, triethylene glycol, an enzyme, a potassium compound, toluene, the like, and any combination thereof.

Once surfaces of the primary structures are impregnated and the aperture filled with reactive fluid, the solid substrate may be used in a SWIRL system and/or SWIRL method of the present disclosure. For example, a method of utilizing a SWIRL system may comprise: contacting a reactive liquid and a working fluid in a SWIRL system, wherein the SWIRL system comprises a solid substrate; and wherein the solid substrate further comprises at least one primary structure and at least one secondary structure. The at least one secondary structure may form at least one aperture such that the average width of the at least one aperture is less than the average void spacing of at least one void of the at least one primary structure.

In any embodiment of the present disclosure with greater than one primary structure, liquid may be removed from at least one void between primary structures allowing for the passage of the working fluid therebetween. In any embodiment of the present disclosure, liquid may be removed from at least one void within at least one primary structure allowing for the passage of the working fluid therewithin.

The reactive liquid may interact with a working fluid to create a liquid-fluid interface. Across the liquid-fluid interface, mass transfer may occur to effect the separation, extraction, and enzyme immobilization. For example, contaminants in the working fluid may be absorbed by the reactive liquid at the liquid-fluid interface. In another example, a component of the working fluid may be extracted from the reactive liquid at the liquid-fluid interface.

The working fluid may be a liquid or may be a gas. Examples of working fluids may include, but are not limited to, an aqueous solution, an organic solution, flue gas, carbon dioxide, water, furfural, air, the like, and any combination thereof.

A further embodiment of the present disclosure provides a method of manufacturing a SWIRL system including a solid substrate. The method may comprise producing at least one primary structure by affixing at least one secondary structure in a spiral configuration or a stacked configuration or a piled configuration, wherein the at least one secondary structure forms at least one aperture with an average width such that the at least one aperture stably contains a reactive liquid; and wherein the solid substrate comprises at least one void with an average void spacing greater than the average width of the at least one aperture.

### Additional Embodiments

To facilitate a better understanding of the embodiments of the present invention, the following examples of preferred or representative embodiments are given. In no way should the following examples be read to limit, or to define, the scope of the invention.

Embodiment 1. A system comprising: a reaction chamber comprising a working fluid inlet and a working fluid outlet; a solid substrate contained within the reaction chamber, wherein the solid substrate has a surface area of greater than 0.001 m²/g and comprises at least one primary structure; wherein a first primary structure of the at least one primary structure comprises at least one secondary structure; wherein the at least one secondary structure forms at least one aperture with an average width such that the at least one aperture stably contains a reactive liquid; and wherein the solid substrate comprises at least one void with an average void spacing greater than the average width of the at least one aperture.

Embodiment 2. The system of Embodiment 1, wherein the at least one secondary structure has an arrangement in a spiral configuration, a piled configuration, a stacked configuration, a stacked pile configuration, or a zig-zag configuration.

Embodiment 3. The system of Embodiment 1 or 2, wherein a second primary structure of the at least one primary structure comprises at least one secondary structure, the at least one secondary structure of the second primary structure has a different arrangement than the at least one secondary structure of the first primary structure.

Embodiment 4. The system of any one of Embodiments 1-3, wherein the at least one secondary structure is at least partially formed by a material comprising: a nonporous structure, a foam, a plurality of fibers, a mesh, or any combination thereof.

Embodiment 5. The system of any one of Embodiments 1-4, wherein the at least one primary structure has a material composition comprising: a metal oxide, a metal, a polymer, or any combination thereof.

Embodiment 6. The system of any one of Embodiments 1-5, wherein the average width is about 1 μm to about 500 μm.

Embodiment 7. The system of any one of Embodiments 1-6, wherein the average void spacing is about 1 μm to about 1000 μm.

Embodiment 8. The system of any one of Embodiments 1-7, wherein the at least one primary structure further comprises at least two primary structures; and wherein the at least one void comprises at least two voids; and wherein there exists an external void of the at least two voids such that the external void is between the at least two primary structures.

Embodiment 9. The system of any one of Embodiments 1-8, wherein the at least one secondary structure has a thickness of about 1 μm to about 500 μm.

Embodiment 10. The system of any one of Embodiments 1-9, wherein the at least one secondary structure has surface features sufficiently spaced such that the surface features stably contain a liquid; and/or wherein the surface features of the at least one secondary structure have an average size of about 0.1 μm to about 100 μm.

Embodiment 11. The system of any one of Embodiments 1-10, wherein the surface features are spaced apart by about 0.1 μm to about 500 μm.

Embodiment 12. The system of any one of Embodiments 1-11, further comprising an A/V of greater than 180 m⁻¹, wherein A is the surface area of the solid substrate and V is a volume of the solid substrate.

Embodiment 13. The system of any one of Embodiments 1-12, wherein the solid substrate has a performance index, PI, of at least 150 m⁻¹.

Embodiment 14. The method of any one of Embodiments 1-13, wherein the reactive liquid impregnates at least 5 vol % of the solid substrate.

Embodiment 15. The system of Embodiment 14, wherein the reactive liquid comprises: an amine, an alkali metal hydroxide, glycol, an enzyme, or any combination thereof.

Embodiment 16. The system of Embodiment 14 or 15, further comprising a working fluid forming a liquid-fluid interface with the reactive liquid.

Embodiment 17. The system of Embodiment 16, wherein the reactive liquid facilitates mass transfer of at least one substance across the liquid-fluid interface.

Embodiment 18. A method comprising: contacting a reactive liquid and a working fluid in a reaction chamber, wherein the reactive liquid is impregnated on a solid substrate; wherein the solid substrate has a surface area of greater than 0.001 m²/g; wherein the solid substrate comprises at least one primary structure; wherein a first primary structure of the at least one primary structure comprises at least one secondary structure; wherein the at least one secondary structure forms at least one aperture with an average width such that the at least one aperture stably contains the reactive liquid; and wherein the solid substrate comprises at least one void with an average void spacing greater than the average width of the at least one aperture.

Embodiment 19. The method of Embodiment 18, wherein the at least one secondary structure has an arrangement in a spiral configuration, a piled configuration, a stacked configuration, a stacked pile configuration, or a zig-zag configuration.

Embodiment 20. The method of Embodiments 18 or 19, wherein the reactive liquid impregnates at least 30% of the surface area of the solid substrate.

Embodiment 21. The method of any one of Embodiments 18-20, wherein the reactive liquid impregnates at least 5 vol % of the solid substrate.

Embodiment 22. The method of any one of Embodiments 18-21, wherein the working fluid is immiscible with the reactive liquid such that a liquid-fluid interface is produced; and wherein at least one substance in the working fluid is extracted by the reactive liquid resulting in mass transfer across the liquid-fluid interface.

Embodiment 23. The method of any one of Embodiments 18-22, further comprising an A/V of greater than 180 m⁻¹, wherein A is the surface area of the solid substrate and V is a volume of the solid substrate.

Embodiment 24. The method of any one of Embodiments 18-23, wherein the solid substrate has a performance index, PI, of at least 150 m⁻¹.

Embodiment 25. The method of any one of Embodiments 18-24, wherein the average width is about 1 μm to about 500 μm.

Embodiment 26. The method of any one of Embodiments 18-25, wherein the average void spacing is about 1 μm to about 1000 μm.

Embodiment 27. The method of any one of Embodiments 18-26, wherein the at least one primary structure further comprises at least two primary structures; wherein the at least one void comprises at least two voids; and wherein there exists an external void of the at least two voids such that the external void is between the at least two primary structures.

Embodiment 28. The method of Embodiment 27, further comprising removing a liquid from the external void, allowing for the passage of the working fluid between the at least two primary structures.

Embodiment 29. The method of any one of Embodiments 18-28, wherein the reactive liquid has a contact angle with the solid substrate in the presence of the working fluid that is less than about 90 degrees.

Embodiment 30. The method of any one of Embodiments 18-29, wherein the working fluid comprises: carbon dioxide, flue gas, water, furfural, air, or any combination thereof.

Embodiment 31. The method of any one of Embodiments 18-30, wherein the reactive liquid comprises: an amine, an alkali metal hydroxide, a potassium compound, toluene, glycol, an enzyme, or any combination thereof.

Embodiment 32. A method of manufacturing a solid substrate, the method comprising: (i) producing at least one primary structure by affixing at least one secondary structure in a configuration; wherein the at least one secondary structure forms at least one aperture with an average width such that the at least one aperture stably contains a reactive liquid; wherein the configuration comprises a spiral configuration, a piled configuration, a stacked configuration, a stacked pile configuration, a zig-zag configuration, or any combination thereof; and (ii) contacting the at least one secondary structure with the reactive liquid; wherein the solid substrate has a surface area of greater than 0.001 m²/g; wherein the solid substrate comprises at least one void with an average void spacing greater than the average width of the at least one aperture; wherein the reactive liquid impregnates at least 30% of the surface area of the solid substrate; and wherein the reactive liquid impregnates at least 5 vol % of the solid substrate.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### EXAMPLES

### Example 1

Four assemblies were prepared for impregnating with TEPA. A summary of data for this example can be seen in Table 1 below.

A first comparative assembly (“CA1”) comprising a single stainless steel mesh substrate of size 2.95 cm×7.32 cm (i.e., an apparent surface area of 21.594 cm² of each side of the substrate and total apparent surface area of 43.188 cm²) with thickness of 0.005 cm and openings between metal strands within the mesh (pores) of width 45 μm was placed in an air oven set to 400° C. for 3 hours.

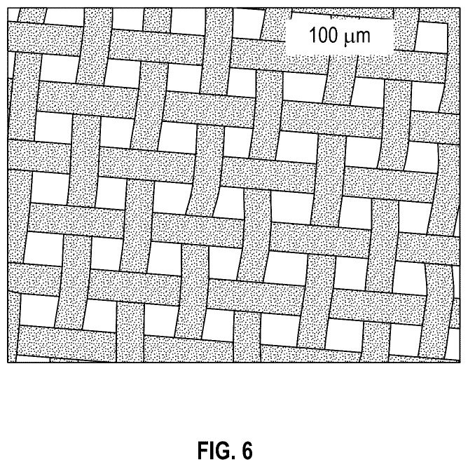

An optical microscope image of the metal sheet is visible in FIG. 6. The edge of the air oven treated metal mesh, kept in a horizontal plane, was introduced to a reservoir of liquid tetraethylenepentamine (TEPA). After maintaining contact with the liquid TEPA for about 5 minutes, no TEPA was observed to begin to impregnate the stainless steel mesh substrate. The weight of the metal mesh substrate before and after contact with TEPA were 0.305 g and 0.3619 g, respectively, thus providing only 0.0569 g of immobilized TEPA. TEPA was observed only at the edge of the metal mesh sheet.

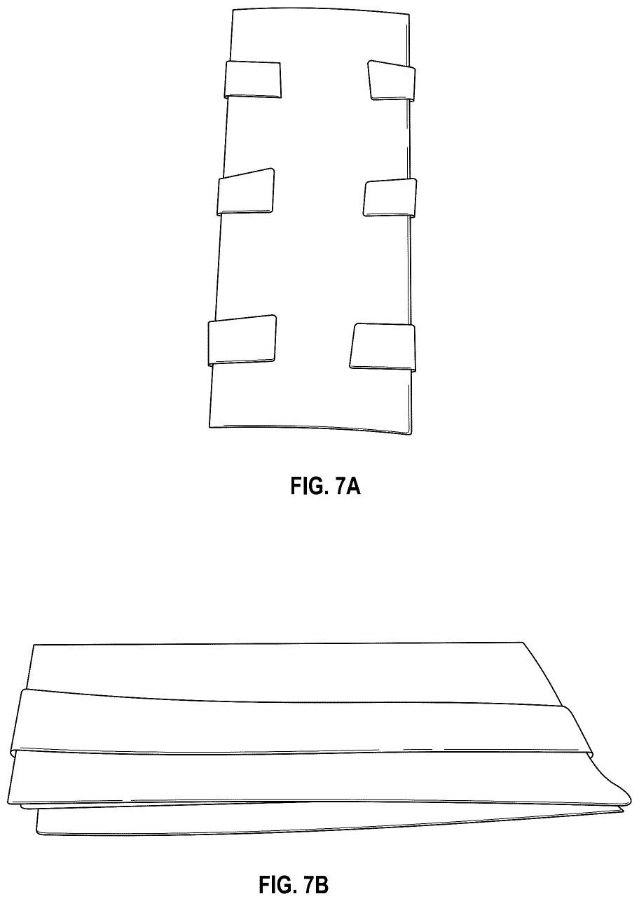

A first exemplary assembly (“EA1”) was constructed by placing three pieces of 2.97 cm×7.37 cm (i.e., an apparent surface area of 21.889 cm² of each side of the substrate and total apparent surface area of 43.778 cm²) stainless steel mesh on top of one another. The pieces together had an apparent total thickness of 150 μm and each had openings between metal strands within the mesh (pores) of width 45 μm. Two views of the constructed assembly are displayed in FIGS. 7A and 7B. The substrate was placed in an air oven set to 400° C. for 3 hours. The edge of the substrate was brought in contact with a small reservoir of TEPA. After 1.5 min, the entire substrate was observed to be impregnated with liquid TEPA. The weight of the substrate before and after contacting with TEPA was 2.1263 g and 2.8490 g, respectively, resulting in 0.7227 g impregnated TEPA. This value is 12.7 times larger than that of CA1. The exemplary assembly provides an equivalent slab of liquid TEPA with a thickness of 0.0349 cm. An equivalent slab is defined as a volume of liquid with overall planar size equivalent to the solid slab (i.e., 2.97 cm×7.37 cm with thickness 0.0349 cm). The density used for TEPA in the equivalent slab calculation was 0.947 g/cc. Additionally, the substrate was observed to swell as it absorbed/was impregnated by the liquid TEPA.

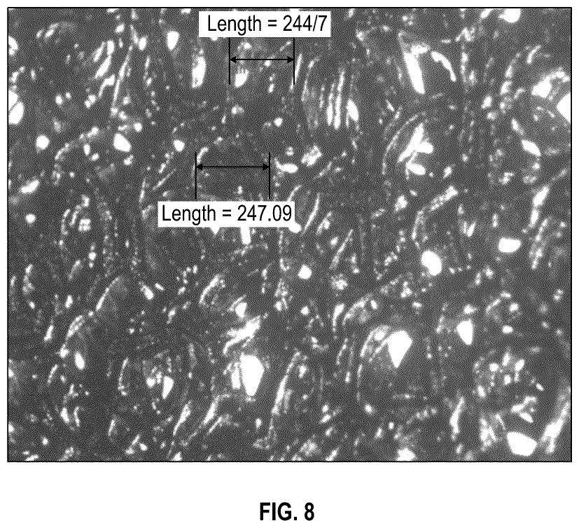

A second comparative assembly (“CA2”) was constructed by obtaining a copper metal foam of size 3.11 cm×7.55 cm (i.e., an apparent surface area of 23.481 cm² of each side of the substrate and total apparent surface area of 46.961 cm²) with a thickness of 0.005 cm and pore openings of width 0.013 cm (130 μm). An optical microscope image of the copper metal foam is shown in FIG. 8. The substrate was placed in an air oven set to 400° C. for 3 hours. The edge of the foam was introduced to a reservoir of liquid TEPA, while keeping the foam in a horizontal plane. After about 5 minutes of contact, no TEPA was observed to impregnate the substrate. The weight of the foam before and after contact with TEPA was 1.4718 g and 1.4763 g, respectively, providing only 0.0045 g of immobilized TEPA. TEPA was observed only at the edge of the metal foam with no spreading.

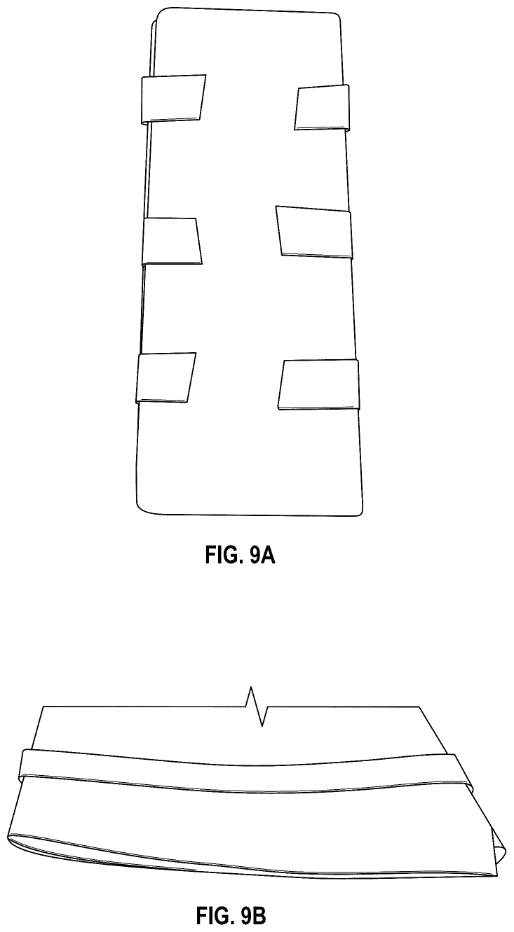

A second exemplary assembly (“EA2”) was constructed by placing three pieces of copper foam with size 3.01 cm×7.55 cm (i.e., a primary structure comprising three pieces of copper foam with total apparent surface area of 45.451 cm²) on top of one another. The pieces together had apparent total thickness of 440 μm and each had pore openings of width 130 μm. Two views of the constructed assembly are displayed in FIGS. 9A and 9B. The substrate was placed in an air oven set to 400° C. for 3 hours. The edge of the substrate was brought in contact with a small reservoir of TEPA. After 1.5 min, the entire substrate was observed to be impregnated with liquid TEPA. The weight of the substrate before and after impregnation with TEPA was 5.4027 g and 6.0897 g, respectively, resulting in 0.687 g impregnated TEPA. This value is 153 times larger than that of CA2. The exemplary assembly provides an equivalent slab of liquid TEPA with a thickness of 0.0319 cm (i.e., a volume of liquid TEPA with area 3.01 cm×7.55 cm and thickness 0.0319 cm). The density used for TEPA in the equivalent slab calculation was 0.947 g/cc.

TABLE 1

| | | | Total Apparent | Pore | Approx. | Mass |
|---|---|---|---|---|---|---|
| Sample | | | Surface Area | Width | Contact | Impregnated |
| ID | Material | Configuration | (cm²) | (μm) | (min) | (g) |
| CA1 | Stainless steel | 1 layer mesh | 43.188 | 45 | 5 | 0.0569 |
| EA1 | Stainless steel | 3 layer mesh | 43.778 | 45 | 1.5 | 0.7227 |
| CA2 | Copper | 1 layer foam | 46.961 | 130 | 5 | 0.0045 |
| | | | | (0.013 | | |
| | | | | cm) | | |
| EA2 | Copper | 3 layer foam | 45.451 | 130 | 1.5 | 0.687 |
| | | | | (0.013 | | |
| | | | | cm) | | |

### Example 2

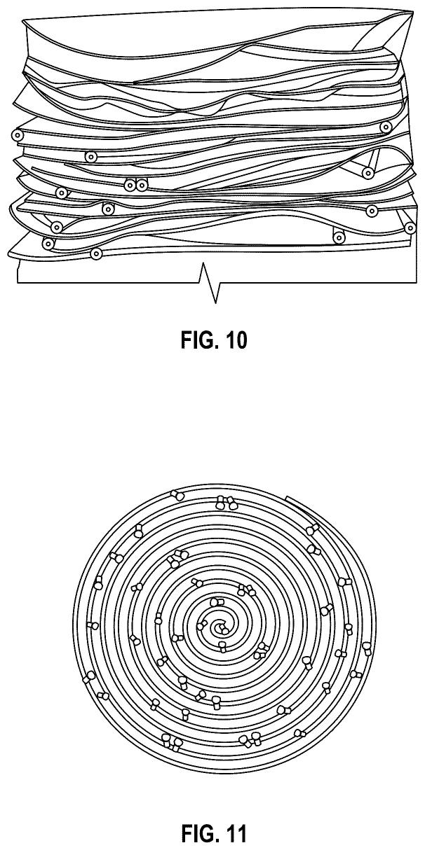

30 layers of approximately 2.5 cm×2.5 cm (i.e., an apparent surface area of CM) stainless steel mesh substrate with apparent total thickness of 150 μm openings between metal strands within the mesh (pores) of width 45 μm were prepared. The assembly was constructed into a square-shaped stacked configuration with 500 μm thick spacers to allow gas flow between the layers of the stack (with each layer having three pieces of stainless steel mesh comprising it), as shown in FIG. 10.

An approximate 2.5 cm wide assembly was constructed by combining three pieces of stainless steel mesh substrate with apparent total thickness of 150 μm and openings between metal strands within the mesh (pores) of 45 μm. The assembly was rolled into a spiral configuration with 500 μm thick spacers to allow gas flow between the layers of the spiral (with each layer having three pieces of stainless steel mesh comprising it), as shown in FIG. 11.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A system comprising:
a reaction chamber comprising a working fluid inlet and a working fluid outlet;
a solid substrate contained within the reaction chamber, wherein the solid substrate has a surface area of greater than 0.001 m²/g and comprises at least one primary structure;
wherein a first primary structure of the at least one primary structure comprises at least one secondary structure;
wherein the at least one secondary structure forms at least one aperture with an average width such that the at least one aperture stably contains a reactive liquid; and
wherein the solid substrate comprises at least one void with an average void spacing greater than the average width of the at least one aperture.

2. The system of claim 1, wherein a second primary structure of the at least one primary structure comprises at least one secondary structure, the at least one secondary structure of the second primary structure has a different arrangement than the at least one secondary structure of the first primary structure.

3. The system of claim 1, wherein the at least one secondary structure is at least partially formed by a material comprising: a nonporous structure, a foam, a plurality of fibers, a mesh, or any combination thereof.

4. The system of claim 1, wherein the at least one primary structure has a material composition comprising: a metal oxide, a metal, a polymer, or any combination thereof.

5. The system of claim 1, wherein the average width is about 1 μm to about 500 μm.

6. The system of claim 1, wherein the average void spacing is about 1 μm to about 1000 μm.

7. The system of claim 1, wherein the at least one primary structure further comprises at least two primary structures; and wherein the at least one void comprises at least two voids; and wherein there exists an external void of the at least two voids such that the external void is between the at least two primary structures.

8. The system of claim 1, wherein the at least one secondary structure has a thickness of about 1 μm to about 500 μm.

9. The system of claim 1, wherein the at least one secondary structure has surface features sufficiently spaced such that the surface features stably contain a liquid; and/or wherein the surface features of the at least one secondary structure have an average size of about 0.1 μm to about 100 μm.

10. The system of claim 1, wherein the at least one secondary structure has surface features, and wherein the surface features are spaced apart by about 0.1 μm to about 500 μm.

11. The system of claim 1, wherein the reactive liquid impregnates at least 5 vol % of the solid substrate.

12. The system of claim 1, further comprising a working fluid forming a liquid-fluid interface with the reactive liquid.

13. The system of claim 12, wherein the reactive liquid facilitates mass transfer of at least one substance across the liquid-fluid interface.

14. A method comprising:
contacting a reactive liquid and a working fluid in a reaction chamber, wherein the reactive liquid is impregnated on a solid substrate;
wherein the solid substrate has a surface area of greater than 0.001 m²/g;
wherein the solid substrate comprises at least one primary structure;
wherein a first primary structure of the at least one primary structure comprises at least one secondary structure;
wherein the at least one secondary structure forms at least one aperture with an average width such that the at least one aperture stably contains the reactive liquid; and
wherein the solid substrate comprises at least one void with an average void spacing greater than the average width of the at least one aperture.

15. The method of claim 14, wherein the reactive liquid impregnates at least 5 vol % of the solid substrate.

16. The method of claim 14, wherein the working fluid is immiscible with the reactive liquid such that a liquid-fluid interface is produced; and wherein at least one substance in the working fluid is extracted by the reactive liquid resulting in mass transfer across the liquid-fluid interface.

17. The method of claim 14, wherein the average width is about 1 μm to about 500 μm.

18. The method of claim 14, wherein the average void spacing is about 1 μm to about 1000 μm.

19. The method of claim 14, wherein the at least one primary structure further comprises at least two primary structures; wherein the at least one void comprises at least two voids; and wherein there exists an external void of the at least two voids such that the external void is between the at least two primary structures.

20. The method of claim 14, wherein the reactive liquid has a contact angle with the solid substrate in the presence of the working fluid that is less than about 90 degrees.
